(19) United States
(12) Patent Application Publication
(10) Pub. No.: US 2014/0346170 A1
(43) Pub. Date: Nov. 27, 2014

(54) UNIVERSAL FILLER CAP ASSEMBLY

(71) Applicant: Voss Intellectual Property, LLC, Fernandina Beach, FL (US)

(72) Inventor: Frederick Voss, III, Fernandina Beach, FL (US)

(73) Assignee: Voss Intellectual Property, LLC, Fernandina Beach, FL (US)

(21) Appl. No.: 14/283,491

(22) Filed: May 21, 2014

Related U.S. Application Data
(60) Provisional application No. 61/826,085, filed on May 22, 2013.

(51) Int. Cl. F17C 13/06

(52) U.S. Cl. CPC F17C 13/06
USPC 220/86.1

(57) ABSTRACT

A universal filler cap assembly having a base member receiving an elastic bushing, a collar, and a cap. The base member has an annular abutting surface and a threaded stem, and the cap has a stem with mating threads. As the cap is threaded onto the base member, the bushing is compressed between the abutting surface and the collar, causing the elastic bushing to bulge in a lateral direction. This bulge presses against the internal surface of the neck of a tank, forming a fluid-tight seal. When the cap is unthreaded from the base member, the compressive force on the bushing is released and it returns to its original shape, snugly fitting around the stem of the base member.

### CROSS-REFERENCE TO RELATED APPLICATION

Pursuant to 35 U.S.C. §119(e), this application claims the benefit of U.S. Provisional Patent Application Ser. No. 61/826,085, filed on May 22, 2013, the entire contents of which are incorporated herein by this reference.

### BACKGROUND

(1) Technical Field

The present invention relates generally to universal filler cap assemblies for tanks that are repeatedly filled and discharged with fluid.

(2) Background

Fillable tanks generally include a variety of portable fuel tanks, spray cans, pressure washers, and the like. These tanks come in all shapes and sizes, and there is no uniform or universal filler cap to fit this wide variety of tanks. When filler caps are lost or broken, replacement caps can be difficult to locate. Often the replacement caps are ill-fitting, which leads to leakage and spillage of the fluid in the tank.

The present invention seeks to overcome these deficiencies by providing a universal filler cap assembly capable of forming a fluid-tight seal in the filler neck of a wide variety of fluid tanks.

### SUMMARY OF THE INVENTION

The filler cap assembly generally comprises a base member, a bushing, a collar, and a cap. The bushing is fitted over the base member, and the collar is fitted over the bushing. The cap is then threaded onto the base member to form the “open position” of the filler cap assembly. As the cap continues to thread along the stem, the cap causes the collar to compress the bushing, and continued compression of the bushing causes it to bulge laterally. This is the “closed position” of the filler cap assembly. Unthreading the cap from the base member releases the compression force on the bushing, and the bushing returns to its original open position, snugly fitting around the stem of the base member.

In use, the filler cap assembly is configured into its open position and is then inserted into the neck of the fluid tank. Once inserted into the neck, the cap is turned to thread the filler cap assembly into its closed position. In this configuration, the bushing presses against the neck of the tank, forming a liquid-tight and vapor-tight tight seal. The filler cap assembly is retained in this position by the friction between the bushing and the neck.

### BRIEF DESCRIPTION OF THE DRAWINGS

FIG. 1 is an exploded view of the universal filler cap assembly, showing cross sections of the base member, bushing, collar, and cap.

FIG. 2 is a cross section of a typical base member of the universal filler cap assembly.

FIG. 3 is a cross section of a typical bushing for the universal filler cap assembly.

FIG. 4 is a cross section of a typical collar for the universal filler cap assembly.

FIG. 5 shows a cross section of one embodiment of a collar, along with a corresponding bottom view of that embodiment.

FIG. 6 is a cross section of a typical cap for the universal filler cap assembly.

FIG. 7 is a cross section showing the universal filler cap assembly in its open position inserted into the neck of a fluid tank.

FIG. 8 is a cross section showing the universal filler cap assembly in its closed position inserted into the neck of a fluid tank.

FIG. 9 is a cross section of an embodiment of the bushing and collar where the collar is bonded to the bushing.

FIG. 10 is a cross section of an embodiment of the bushing having an annular ridge for contacting large neck openings.

FIG. 11 is a cross section of a cap having external threads.

FIG. 12 is a cross section of an alternate embodiment of the universal filler cap assembly.

FIG. 13 is a perspective view of the universal filler cap assembly connected to a typical fluid tank and having a cap with an adapter for mating with an external fluid supply system.

FIG. 14 is a cross section of the filler cap assembly used in connection with a quick disconnect adapter and a conventional portable fuel tank.

FIG. 15 shows detail B as denoted in FIG. 14.

FIG. 16 is an isometric view of three different sizes of filler cap assemblies for use in connection with a quick disconnect adapter.

FIG. 17 is a cross section of a typical filler cap assembly for use in connection with a quick disconnect adapter.

### DETAILED DESCRIPTION OF THE INVENTION

With reference to the drawings, the invention will now be described with regard to the best mode and the preferred embodiment. In general, the device is an adjustable, universal filler cap assembly for fluid-receiving tanks. Such fluid tanks include a variety of portable fuel tanks, the tanks in portable petroleum powered tools, pressure washers, spray cans, and the like. The embodiments disclosed herein are meant for illustration and not limitation of the invention. An ordinary practitioner will understand that it is possible to create many variations of the following embodiments without undue experimentation.

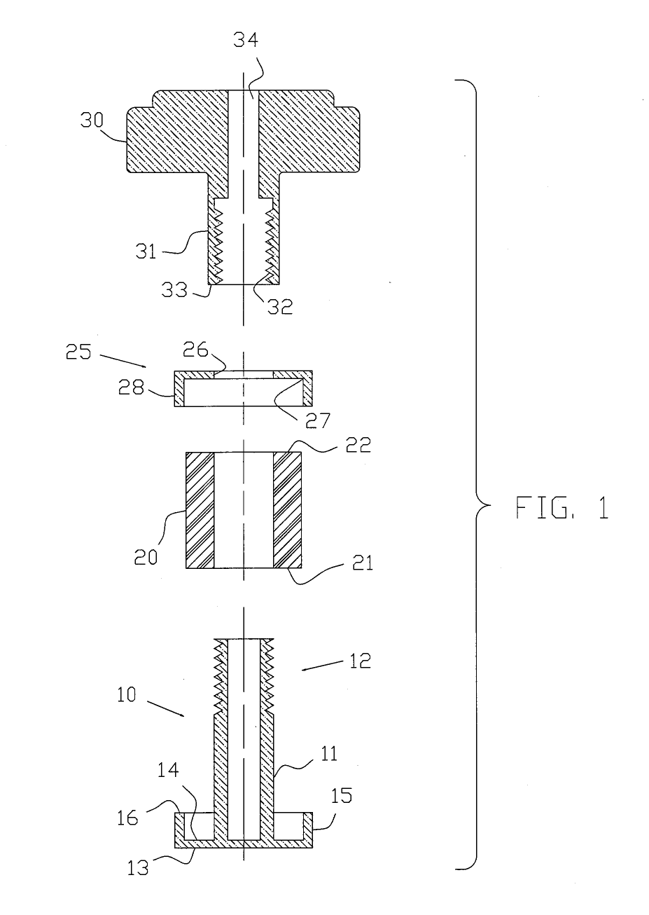

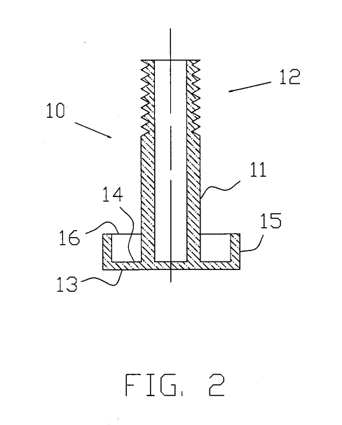

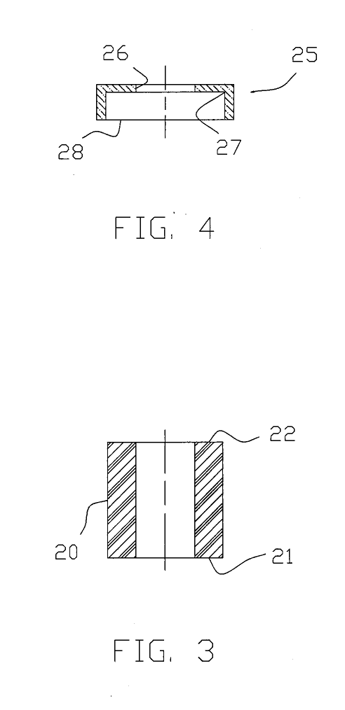

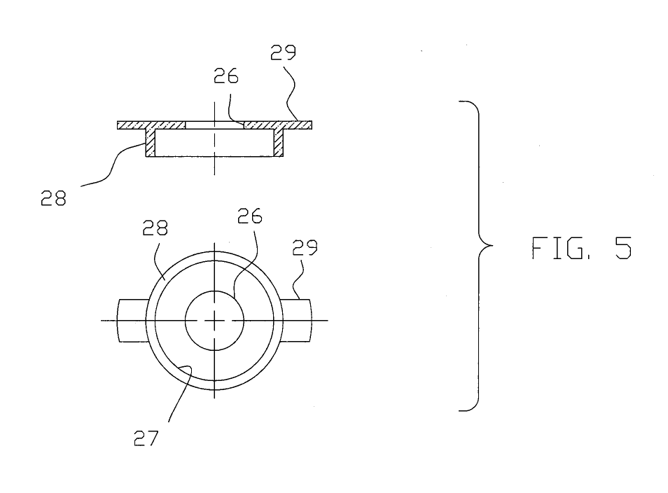

Referring to FIGS. 1-4, the filler cap assembly 1 generally comprises a base member 10, a bushing 20, a collar 25, and a cap 30. The base member 10 comprises a cylindrical stem 11 having a threaded section 12 located proximately to one end of the cylindrical stem 11. the opposite end of the cylindrical stem comprises a flange 13. The flange 13 provides an abutting surface 14 for abutting the bushing 20, as described below. It may be beneficial, but not necessary, for the flange 13 to comprise a retaining member 15 connected to the outer edge of the flange 13. For example, the retaining member 15 could be one or more clips, stems, clamps or the like extending from the flange 13 and configured to retain the bushing 20 in place, as described below. One embodiment of the retaining member 15 is an annular rim 16 that is connected to the outer edge of the flange 13 and extends substantially parallel to the cylindrical stem 11.

The bushing 20 is a hollow cylindrical member where the inner diameter is sized to snugly fit over the stem 11 of the base member 10. The bushing 20 comprises an elastic material that deforms under a compressive force and resiliently returns to its original shape upon release of the compressive force. Such materials include a variety of natural or synthetic rubber materials, plastics, elastomeric materials, or the like. Preferably, the material is resistant to deterioration under prolonged exposure to fuels or other fluids that may be corrosive or otherwise harsh or harmful. As a non-limiting example, the bushing 20 material is a fluoroelastomer categorized under the ASTM D1418 and ISO 1629 designations, which identify a family including copolymers of hexafluoropropylene and vinylidene fluoride, terpolymers of tetrafluoropropylene, vinylidene fluoride and hexafluoropropylene, and other similar materials. Viton synthetic rubber is one such material.

As the stem 11 slidably receives the bushing 20, the base 21 of the bushing 20 abuts the abutting surface 14 of the flange 13. The base 21 remains seated against the abutting surface 14 of the flange 13. The retaining member 15, if any, assists in retaining the bushing 20 in this seated position.

The collar 25 is shaped like a conventional washer, having an inner diameter 26 and an outer diameter 27. The inner diameter 26 is sized to snugly receive the cylindrical stem 11 of the base member 10. The collar 25 is fitted over the stem 11 and placed in contact with the top 22 of the bushing 20. Optionally, the collar 25 is fitted with an annular rim 28 having an inner diameter sized to snugly receive the outer diameter of the bushing 20. In another embodiment of the collar 25, shown in FIG. 5, the collar 25 further comprises tabs 29 extending laterally from the collar 25. These tabs 29 provide handling points for the user to manipulate the device.

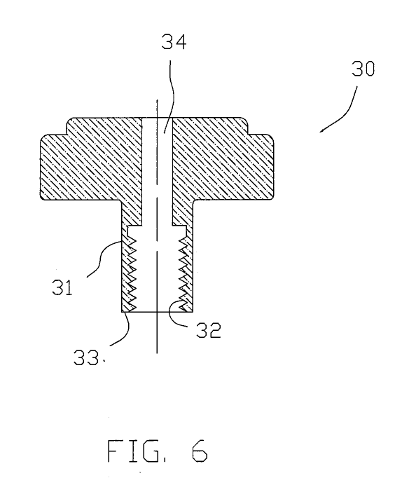

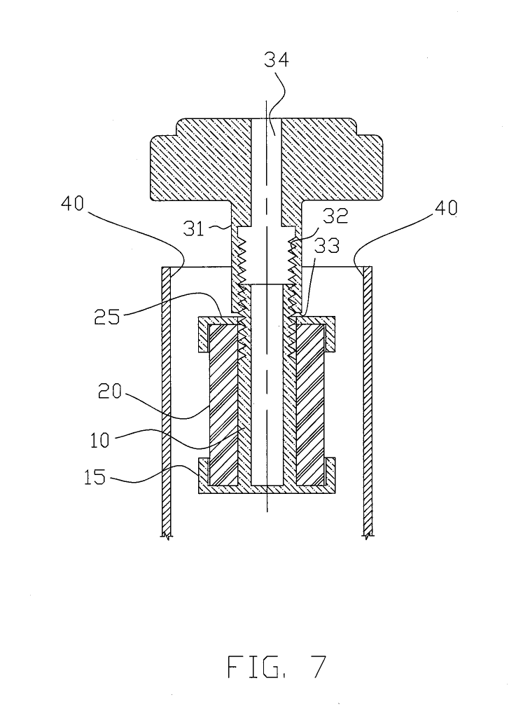

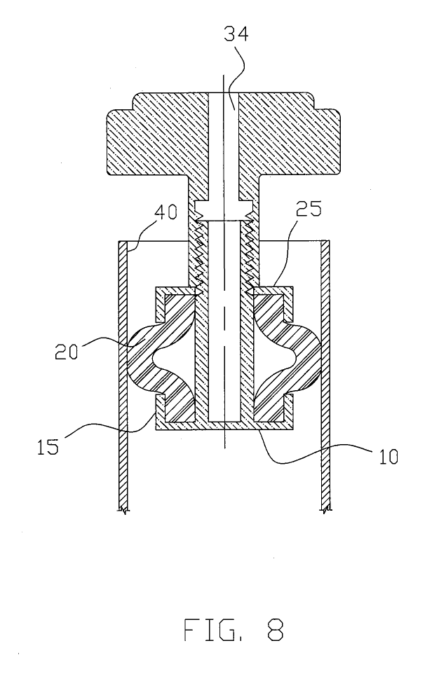

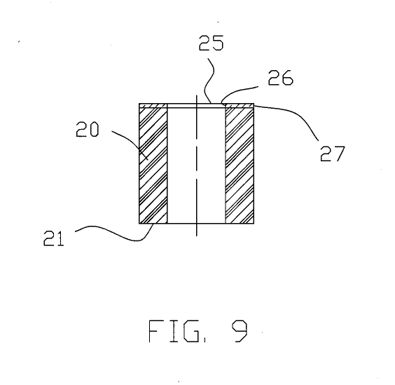

Referring to FIG. 6, the cap 30 has hollow cylindrical stem 31 having internal threads 32 that mate with the threaded section 12 of the base member 10. The bottom of the cap stem 31 has an actuating end 33. After the bushing 20 and collar 25 are fitted over the stem 11, the cap 30 is then threaded onto the stem 11 before contacting the collar 25. This is the “open position” of the filler cap assembly 1, as shown in FIG. 7. As the cap 30 continues to thread along the stem 11, the actuating end 33 abuts the collar 25, pressing it against the bushing 20. Continued turning of the cap 30 relative to the base member 10 threads the cap 30 onto the base member 10 and causes the collar 25 and the abutting surface 14 to compress the bushing 20, and continued compression of the bushing 20 causes it to bulge laterally. This is the “closed position” of the filler cap assembly 1, as shown in FIG. 8. Unthreading the cap 30 from the base member 10 releases the compression force on the bushing 20, and the bushing 20 returns to its original open position, snugly fitting around the stem 11 of the base member 10.

In use, the filler cap assembly 1 is configured into its open position and is then inserted into the neck 40 of the fluid tank 41 that is to be filled. Once inserted into the neck 40, the cap 30 is turned to thread the filler cap assembly 1 into its closed position. In this configuration, shown in FIG. 8, the bushing 20 presses against the neck 40 of the tank 41, forming a liquid-tight and vapor-tight tight seal. The filler cap assembly 1 is retained in this position by the friction between the bushing 20 and the neck 40.

In most embodiments, the bushing 20 has a relatively tacky surface that creates friction when in contact with plastic and metal surfaces. The collar 25 is in contact with the bushing 20 on one side of the collar 25, and the friction at this interface prevents the collar 25 from turning in relation to the bushing 20 as the cap 30 is threaded onto the base member 10. On the opposite side of the collar 25, the contact surface between the collar 25 and the actuating end 33 is an interface between plastic or metal members and is relatively friction free compared to the collar 25/bushing 20 contact surface. Thus, as the cap 30 turns relative to the base member 10, the low-friction contact surface between the actuating end 33 and the collar 25 forms a slip-plane, permitting those two members to turn in relation to each other and allowing the cap 25 to turn relative to the base member 10 during the threading process. In another embodiment, the collar 25 could be permanently attached to the bushing, as shown in FIG. 9. In this embodiment, the collar 25 is a washer with or without an annular rim 28, and the collar 25 is bonded to the bushing 20 by an adhesive, glue, or the like.

In another embodiment, shown in FIG. 5, the tabs 29 of the collar 25 provide gripping points so that the user can hold the collar 25 in place via the tabs 29 while the cap 30 is threaded onto the base member 10. Alternately, the filler cap assembly 1 can be partially closed so that the busing 20 begins to bulge. The lateral bulge in the bushing 20 can be sized to snugly fit inside the neck 40, providing a contact surface between the bushing 20 and the neck 40. The friction at this contact surface will hold the bushing 20 and base member 10 in place while the cap 30 continues to thread into the fully closed position of the filler cap assembly 1. In this closed position, the friction between the bushing 20 and neck 40 will prevent the filler cap assembly 1 from being inadvertently dislodged from the neck 40.

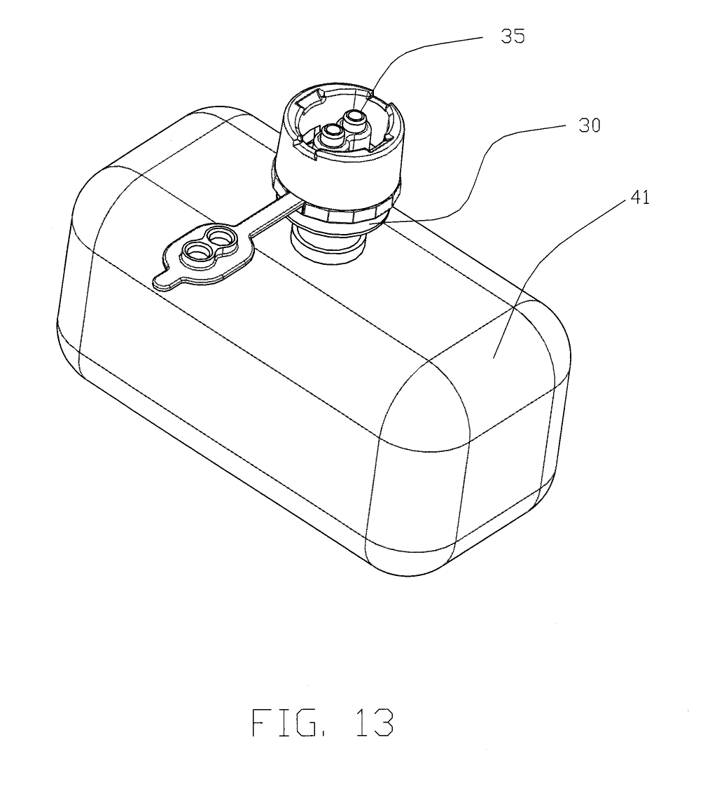

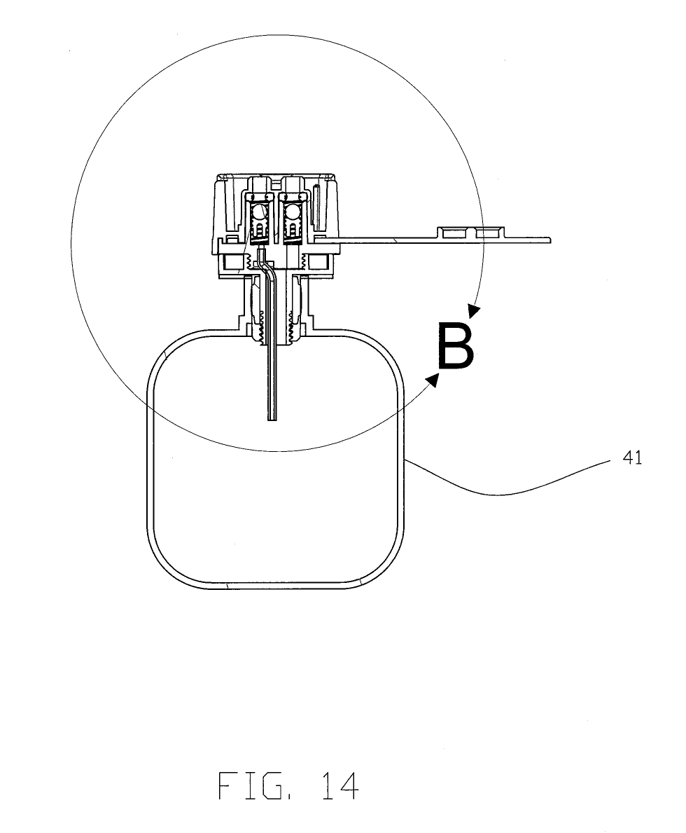

In another embodiment of the filler cap assembly 1, the cap 30 further comprises a port 34 for permitting the passage of fluid through the cap 30 and into or out of the tank 41. This port 34 permits the tank 41 to be repeatedly filled and discharged without removing the filler cap assembly 1 from the neck 40 of the tank 41. In a variation of this embodiment, shown in FIG. 13, the external surface of the cap 30 further comprises an adapter 35 for mating with an external fluid supply system. For example, the adapter 35 could be a quick disconnect coupling for mating with a corresponding coupling on an external fluid supply line. As another example, the adapter 35 could be a flap valve for receiving the nozzle of a typical unleaded gasoline pump. The adapter 35 could comprise independent non-spill properties, such as valves that are biased closed until they are mated with the coupling end of an external fluid supply line.

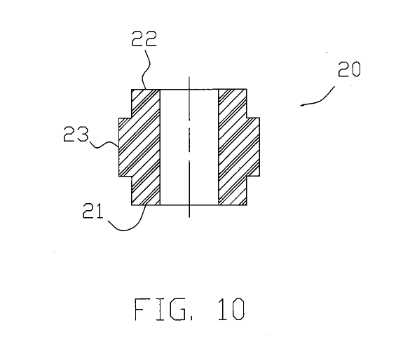

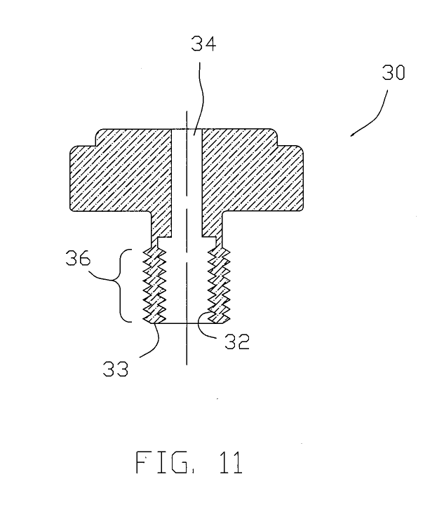

The foregoing embodiments of the filler cap assembly 1 are well suited for use in small conventional tanks, such as portable fuel tanks, fuel tanks for lawn mowers, weed trimmers and other hand-held power tools, pressure washers, spray cans, and the like. However, in some tanks 41, the neck 40 is of a larger size. Another embodiment of the bushing 20, shown in FIG. 10, is used to accommodate these larger neck 40 sizes. In this embodiment, the bushing 20 comprises an annular ridge 23 that widens the bushing 20, permitting a fluid-tight seal in the wider necks 40.

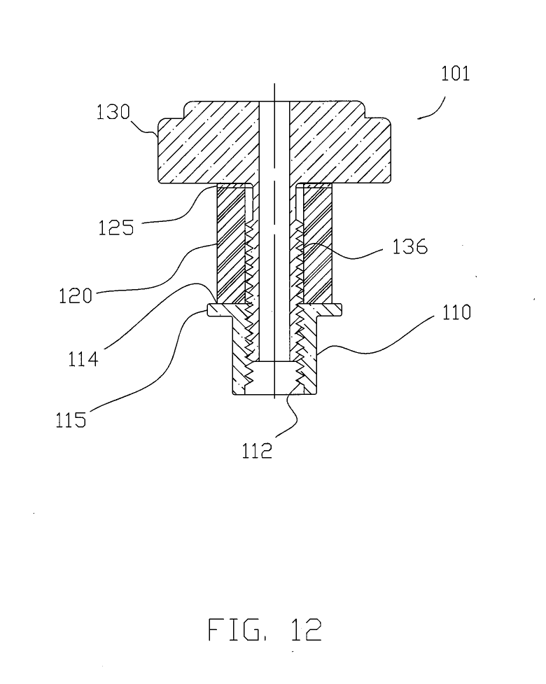

In some fluid tanks, the neck 40 comprises threads internal to the neck 40 or internal to the standard filler cap corresponding to the neck 40. To accommodate these threads, another embodiment of the filler cap assembly 1, shown in FIG. 11, includes a cap 30 that further comprises external threads 36 along the stem 31 of the cap 30. These external threads 36 are threaded into the mating threads inside the neck 40 or inside the standard filler cap that accompanies the fluid tank 41.

In another embodiment of the filler cap assembly 101, shown in FIG. 12, the base member 110 takes the form of a flanged busing having internal threads. The base member 110 has an abutting surface 114 for abutting the bushing 120. For example, the base member 110 could comprise an annular flange 113 disposed horizontally such that one side of the flange 113 forms the abutting surface 114 for abutting the bushing 120. The threaded section 112 of the base member 110 is disposed inside the hollow cylindrical body of the base member 110. In this embodiment, the bushing 120 and the collar 125 are configured as discussed in the embodiments above. The cap 130 is also configured according to the embodiments above, with the exception that the external threads 136 engage the internal threaded section 112 of the base member 110 in the manner shown in FIG. 12. In this embodiment, the cap 130 is partially threaded into the base member 110, causing the busing 120 to bulge laterally so that the bushing will snugly fit into the neck 40 of the fluid tank 41. The filler cap assembly 101 is then lodged into the neck 40, and the cap 130 is turned so that the cap 130 continues to thread into the base member 110. This threading action is continued until the filler cap assembly 101 is adjusted to the desired tightness inside the neck 40. After use, the filler cap assembly 101 is removed from the neck 40 in the manner described in the embodiments above.

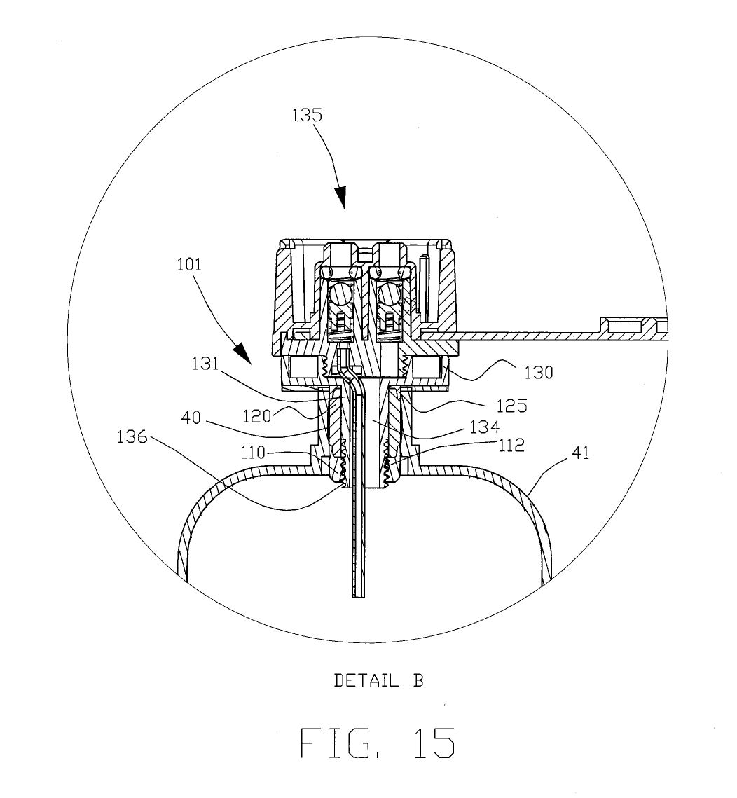

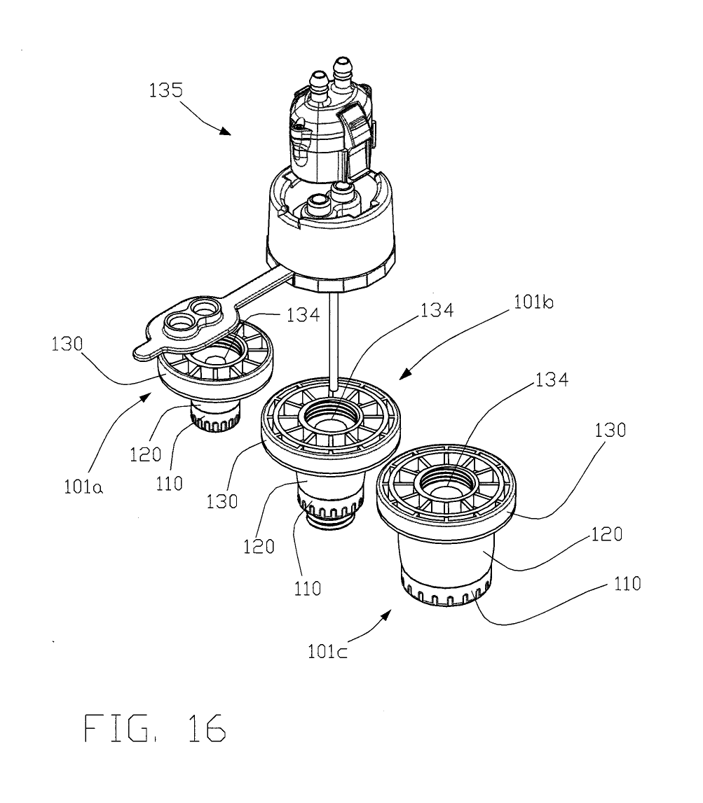

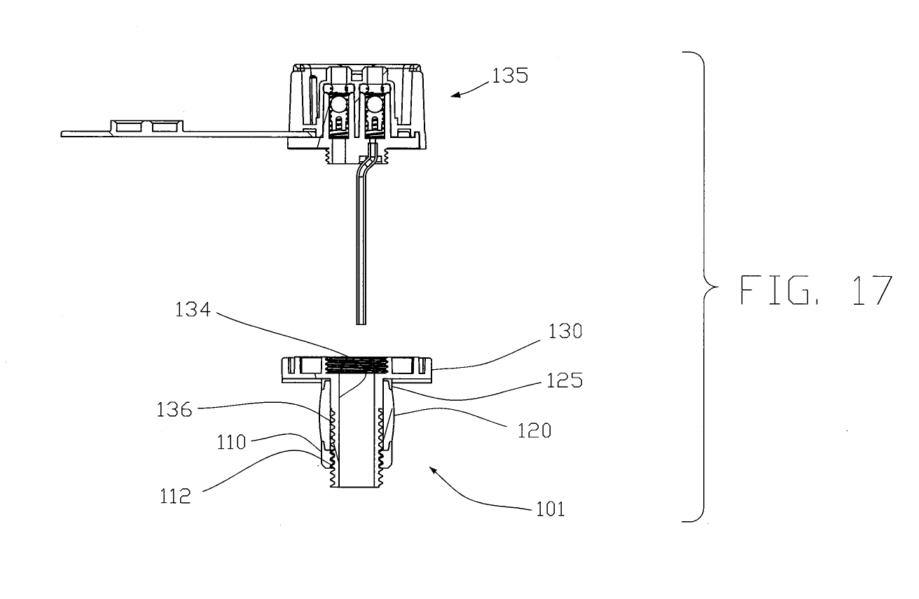

FIGS. 14 and 15 show one embodiment of the filler cap assembly 101 of FIG. 12 used in connection with an external fuel tank 41 and a quick disconnect adapter 135 for connecting with an external fuel supply system (not shown). In this configuration, the filler cap assembly 101 enables fuel to pass through the port 134 of the stem 131 and into the fuel tank 41. FIG. 16 shows three different sizes of the filler cap assembly 101a, 101b, 101c used in connection with a single quick disconnect adapter 135. The different sized filler cap assemblies 101a, 101b, 101c enable the system to be used with fuel tanks 41 of different sizes. Depending on the application, the filler cap assemblies 101a, 101b, 101c of the most appropriate size is selected for use in connection with the adapter 135. FIG. 17 shows a typical cross section of a filler cap assembly 101 in connection with an adapter 135.

The foregoing embodiments are merely representative of the universal filler cap assembly and not meant for limitation of the invention. For example, one having ordinary skill in the art would understand that there are several embodiments and configurations of base members, caps, bushings, and other components that will not substantially alter the nature of the filler cap assembly. As another example, in any of the embodiments above the threads on the base member and the cap could be reversed so that the base member is threaded into the cap (as shown in FIG. 8), or such that the base member is threaded over the cap (as shown in FIG. 12). Consequently, it is understood that equivalents and substitutions for certain elements and components set forth above are part of the invention described herein, and the true scope of the invention is set forth in the claims below.

I claim:

1. An adjustable, universal filler cap assembly for fluid-receiving tanks, said assembly comprising:
a hollow cylindrical base member having an annular flange with an abutting surface, said base member having internal threads;
a hollow cylindrical bushing comprising a resilient elastic material that deforms laterally under a compressive force;
a cap having a stem, wherein the stem comprises external threads; and
a collar having an inner diameter slightly larger than the diameter of the stem of the cap such that the collar snugly receives the stem, said collar having an outer diameter slightly larger than the outer diameter of the bushing,
wherein the bushing is sized to snugly receive the stem, and the internal threads of the base member mate with the external threads of the stem, such that threading the stem into the base member causes the bushing to be compressed between the collar and the abutting surface, thereby causing the bushing to bulge laterally in a direction perpendicular to the orientation of the stem.

2. The assembly of claim 1, wherein the bushing has a top and a base and the annular flange comprises a retaining member to retain the base of the busing from lateral displacement when the busing is under compression.

3. The assembly of claim 1, wherein the bushing has a top and a base and the collar further comprises an annular rim configured to retain the top of the bushing from lateral displacement when the busing is under compression.

4. The assembly of claim 1, wherein the collar further comprises one or more tabs extending laterally from the collar, said tabs providing a handling point for the user.

5. The assembly of claim 2, wherein the collar further comprises one or more tabs extending laterally from the collar, said tabs providing a handling point for the user.

6. The assembly of claim 1, wherein the bushing further comprises an annular ridge protruding laterally from the bushing.

7. The assembly of claim 2, wherein the bushing further comprises an annular ridge protruding laterally from the bushing.

8. The assembly of claim 4, wherein the bushing further comprises an annular ridge protruding laterally from the bushing.

9. An adjustable, universal filler cap assembly for fluid-receiving tanks, said assembly comprising:
a base member having an annular flange with an abutting surface, said base member having external threads;
a hollow cylindrical bushing comprising a resilient elastic material that deforms laterally under a compressive force;
a cap having a hollow cylindrical stem, wherein the stem comprises internal threads; and
a collar having an inner diameter slightly larger than the diameter of the stem of the cap such that the collar snugly receives the stem, said collar having an outer diameter slightly larger than the outer diameter of the bushing,
wherein the bushing is sized to snugly receive the stem, and the external threads of the base member mate with the internal threads of the stem, such that threading the stem into the base member causes the bushing to be compressed between the collar and the abutting surface, thereby causing the bushing to bulge laterally in a direction perpendicular to the orientation of the stem.

10. The assembly of claim 9, wherein the bushing has a top and a base and the annular flange comprises a retaining member to retain the base of the busing from lateral displacement when the busing is under compression.

11. The assembly of claim 9, wherein the bushing has a top and a base and the collar further comprises an annular rim configured to retain the top of the bushing from lateral displacement when the busing is under compression.

12. The assembly of claim 9, wherein the collar further comprises one or more tabs extending laterally from the collar, said tabs providing a handling point for the user.

13. The assembly of claim 10, wherein the collar further comprises one or more tabs extending laterally from the collar, said tabs providing a handling point for the user.

14. The assembly of claim 9, wherein the bushing further comprises an annular ridge protruding laterally from the bushing.

15. The assembly of claim 10, wherein the bushing further comprises an annular ridge protruding laterally from the bushing.

16. The assembly of claim 12, wherein the bushing further comprises an annular ridge protruding laterally from the bushing.
